(19) United States
(12) Patent Application Publication
(10) Pub. No.: US 2015/0064571 A1
(43) Pub. Date: Mar. 5, 2015

(54) CURRENT COLLECTOR STRUCTURE

(71) Applicant: Enerage Inc., Wujie Township (TW)

(72) Inventors: Mark Y. Wu, Wujie Township (TW); Cheng-Yu Hsieh, Wujie Township (TW); Rui-Jun Cheng, Wujie Township (TW); Shu-Ling Hsieh, Wujie Township (TW); Jing-Ru Chen, Wujie Township (TW)

(73) Assignee: Enerage Inc., Wujie Township (TW)

(21) Appl. No.: 14/098,135

(22) Filed: Dec. 5, 2013

(30) Foreign Application Priority Data
Aug. 28, 2013 (TW) 102130858

(51) Int. Cl. H01M 4/66

(52) U.S. Cl. CPC H01M 4/667
USPC 429/245

(57) ABSTRACT

A current collector structure includes a metal foil substrate and a graphene conductive layer provided on at least one surface of the metal foil substrate. The graphene conductive layer includes a plurality of graphene sheets and a polymer binder used to bind the graphene sheets together and to adhere the graphene sheets onto the metal foil substrate. The conductive layer has a thickness of 0.1 μm to 5 μm and a resistance less than 1 Ω-cm. The polymer binder increases the adhesion force, such that the integrated conductive network is thus formed. Since the polymer binder is well compatible with the binder as the active material contained in the electrochemical element. The active material of the electrochemical element is thus tightly bound with the graphene conductive layer so as to minimize the contact resistance and greatly improve the performance of the electrochemical element.

### CROSS-REFERENCE TO RELATED APPLICATION

This application claims the priority of Taiwanese patent application No. 102130858, filed on Aug. 28, 2013, which is incorporated herewith by reference.

### BACKGROUND OF THE INVENTION

1. Field of the Invention

The present invention generally relates to a current collector structure, and more specifically to a current collector structure, which includes a graphene conductive film.

2. The Prior Arts

The monolayer graphite, also called graphene, possess a lattice structure consisting of a monolayer of carbon atoms bound by sp2 chemical bond and closely packed to form a two dimensional honeycomb shape. Thus, graphene has a thickness of only one carbon atom. The graphitic bond is a hybrid chemical bond from a covalent bond and a metallic bond. It is believed that graphene is a perfect combination of an electrical insulator and an electrical conductor. Andre Geim and Konstantin Novoselov, who successfully obtained graphene by peeling a piece of graphite with adhesive tape at the University of Manchester in the UK in 2004, were thus awarded the Nobel Prize in Physics for 2010.

Presently, graphene is the thinnest and hardest material in the world. Its thermal conductivity is greater than that of carbon nanotube and diamond, and its electron mobility at room temperature is higher than that of the carbon nanotube and silicon crystal. Additionally, the electric resistivity of graphene is even lower than that of copper or silver. So far, graphene is considered as the material with the lowest resistivity. The unique electrical and mechanical properties allow the composite material added with graphene to provide various functions not only with excellent mechanical and electrical performance, but also superior processability so as to greatly expand the application field of the composite material. Specifically, graphene is a two dimensional crystal bound by benzene-ring chemical bond, which is chemically stable with inert surfaces. Thus, its interaction with other medium (like solvents) is weak. Pieces of graphene are easily congregated because of strong van der waals forces between thereof such that graphene sheets are difficult to dissolve in water and in commonly used organic solvents. In particular, it is not easy to well blend graphene with other materials to form composite material. Graphene is therefore greatly limited in further research and actual application. For now, traditional composite materials are formed of other graphitic materials or carbon materials.

US patent publication No. 2012/0,237,782 disclosed “CARBON COATED ALUMINUM FOIL AS CATHODE OF SOLID ALUMINUM ELECTROLYTIC CAPACITOR AND MANUFACTURING METHOD THEREOF”, in which carbon atoms are deposited on the aluminum foil by the plasma process so as to enhance the mechanical strength of the aluminum foil. Additionally, the carbon coated aluminum foil is applied to the capacitor to improve the electrical conductivity and power density.

US patent publication No. 2013/0,171,517 also disclosed “CURRENT COLLECTOR, ELECTRODE OF ELECTROCHEMICAL BATTERY, AND ELECTROCHEMICAL BATTERY USING THE SAME”. First, graphene sheets with 1˜10 layers are prepared in powder form and dispersed in a volatile solvent, like organic solvent or water, to form a graphene dispersion. A mass percentage of the plurality of graphene powders to the graphene dispersion can be in a range from about 0.05 wt % to about 5 wt %. Then, by dipping, the graphene dispersion is coated on at least one surface of a metal foil to form a coating layer, which has a thickness of 0.8 to 5 μm. Finally, the volatile solvent is removed by heat drying or air drying to form the graphene film on the surface of the metal foil. As a result, the graphene current collector is obtained. Since graphene and the metal material are quite different in intrinsic properties, poor affinity between thereof is resulted in such that the adhesion of graphene to the metal foil is weak. Particularly, the junction of graphene and the metal foil possibly forms an electrical resistive layer. Moreover, the thickness of the coated graphene layer is hard to control because of the dipping process used to manufacture the graphene current collector. It is possible that the process by coating graphene on the metal foil still has difficulties in actual application.

Therefore, it is greatly desired to provide a current collector structure, which utilizes graphene with the excellent and unique property of electrical conductivity to replace traditional carbon coated layer, and is feasibly applied to current electrochemical products to solve the above problems of poor affinity and adhesion in the prior arts, thereby exhibiting the intrinsic properties of graphene.

### SUMMARY OF THE INVENTION

The primary objective of the present invention is to provide a current collector structure comprising a metal foil substrate and a graphene conductive layer. The graphene conductive layer has a thickness of 0.1˜5 μm, and its resistivity is less than 1 Ω-cm. Specifically, the graphene conductive layer comprises a plurality of graphene sheets and a polymer binder that is used to bind the graphene sheets together and that adheres the bound graphene sheets on the metal foil substrate. The polymer binder has a weight ratio to the graphene conductive layer within a range of 0.01 wt % to 10 wt %.

With the polymer binder, the graphene sheets are adhered to the metal foil substrate, and the adhesion between the graphene sheets and the metal foil substrate is enhanced such that the adhesion strength of the whole current collector structure is greatly improved. As a result, the integrated conductive network is formed. Furthermore, the polymer binder is well compatible with the binder used in the active material contained in the electrochemical element, and the active material of the electrochemical element is tightly bound with the graphene conductive layer such that the contact resistance between thereof is reduced to a minimum value, thereby greatly improving the performance of the electrochemical element. It is obviously seen that the current collector structure of the present invention can be applied to various batteries, capacitors, and so on.

### BRIEF DESCRIPTION OF THE DRAWINGS

The present invention can be understood in more detail by reading the subsequent detailed description in conjunction with the examples and references made to the accompanying drawings, wherein:

FIG. 1 is a view schematically showing a current collector structure according to one embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

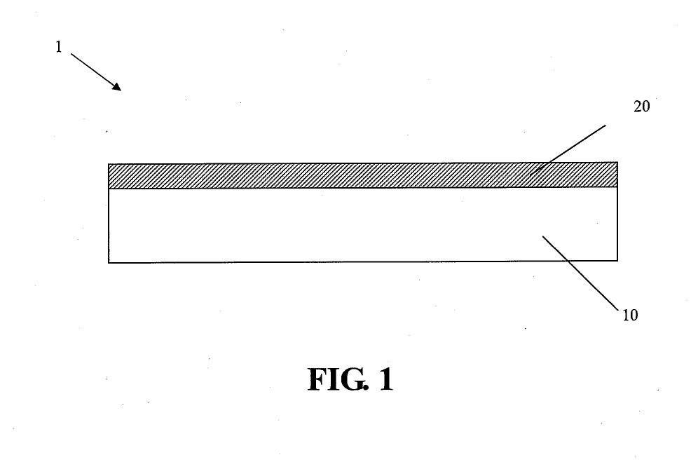

Please refer to FIG. 1, which shows a current collector structure according to one embodiment of the present invention. As shown in FIG. 1, the current collector structure 1 of the present invention comprises a metal foil substrate 10 and a graphene conductive layer 20. For example, the metal foil substrate 10 is selected from a group comprising at least one of aluminum foil, copper foil, titanium foil and nickel foil. The graphene conductive layer 20 is provided on at least one surface of the metal foil substrate 10. Specifically, the graphene conductive layer 20 has a thickness of 0.1˜5 μm, and its resistivity is preferably less than 1 Ω-cm. The graphene conductive layer 20 comprises a plurality of graphene sheets and a polymer binder. The polymer binder is used to bind the graphene sheets together and to adhere the bound graphene sheets onto the metal foil substrate 10. The polymer binder has a weight ratio to the graphene conductive layer 20 within a range of 0.01 wt % to 10 wt %.

In particular, the graphene sheet has a shape of thin flake with a thickness of 1 nm˜50 nm and a planar lateral dimension of 1 μm˜50 μm. It is preferred that the polymer binder is selected from a group consisting of polyvinylidene fluoride, polyethylene terephthalate, polyurethane, polyethylene oxide, polyacrylonitrile, polyacrylamide, poly(methyl acrylate), polymethyl methacrylate, polyvinyl acetate, polyvinyl pyrrolidone, polytetraglycol Diacrylate, polyimide, cellulose acetate, cellulose acetate butyrate, cellulose acetate propionate, ethyl cellulose ethoce, cyano ethyl cellulose, cyano ethyl polyvinyl alcohol and carboxy methyl cellulose. For instance, the polymer binder becomes gel state when contacting the electrolyte contained in the battery.

Hereinafter is an illustrative example used to generally describe the processes of manufacturing the current collector structure of the present invention. Firstly, the graphene sheets are well dispersed in N-methyl pyrrolidinone (NMP) as the solvent, and then polyvinylidene fluoride (PVDF) is added as the polymer binder. Next, after several hours of ball grinding, the above dispersion forms a graphene slurry. The slurry is coated on the metal foil substrate formed of aluminum and well dried to evaporate NMP so as to form the graphene conductive layer. The current collector structure of the present invention is thus manufactured. Four point probe measurement is used to measure the resistance of the current collector structure of the present invention.

The following experimental examples Ex 1-Ex5 are different in the amount of PVDF added in the current collector structure and the thickness of the coated graphene conductive layer. Table 1 shows the result of measurement.

TABLE 1

| | polymer | | | |
|---|---|---|---|---|
| | binder | Thickness of graphene | Resistivity | |
| | (wt %) | conductive layer (μm) | (Ω-cm) | substrate |
| Ex 1 | 0.46 | 2 | 8.376 * 10⁻¹ | Aluminum foil |
| Ex 2 | 0.24 | 2 | 6.000 * 10⁻⁴ | Aluminum foil |
| Ex 3 | 0.24 | 1 | 2.971 * 10⁻⁴ | Aluminum foil |
| Ex 4 | 0.12 | 2 | 2.954 * 10⁻⁵ | Aluminum foil |
| Ex 5 | 0.12 | 1 | 2.104 * 10⁻⁶ | Aluminum foil |

Furthermore, the graphene conductive layer and the metal foil substrate are tested to measure the adhesion force between thereof by a cross-cut method with 3M 600 and 610 tapes. The result shows the adhesion force is classified with larger than or equal to 4B level.

As mentioned above, one aspect of the present invention is that the graphene sheets are adhered to the metal foil substrate through the polymer binder, which binds the graphene sheets together such that the adhesion force is increased and the integrated conductive network is thus formed. As for electrochemistry, the polymer binder is well compatible with the binder used in the active material contained in the electrochemical element. The active material of the electrochemical element is thus tightly bound with the graphene conductive layer so as to minimize the contact resistance and greatly improve the performance of the electrochemical element. Therefore, the present invention is obviously suitable applied to various batteries, capacitors, and so on.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A current collector structure, comprising:
a metal foil substrate; and
a graphene conductive layer provided on at least one surface of the metal foil substrate, and comprising a plurality of graphene sheets and a polymer binder used to bind the graphene sheets together and adhere the graphene sheets to the metal foil substrate,
wherein the graphene sheet has a shape of thin flake with a thickness of 1 nm to 50 nm and a planar lateral dimension of 1 μm to 50 μm.

2. The current collector structure as claimed in claim 1, wherein the metal foil substrate is selected from a group comprising at least one of aluminum foil, copper foil, titanium foil and nickel foil.

3. The current collector structure as claimed in claim 1, wherein the polymer binder is selected from a group consisting of polyvinylidene fluoride, polyethylene terephthalate, polyurethane, polyethylene oxide, polyacrylonitrile, polyacrylamide, poly(methyl acrylate), polymethyl methacrylate, polyvinyl acetate, polyvinyl pyrrolidone, polytetraglycol Diacrylate, polyimide, cellulose acetate, cellulose acetate butyrate, cellulose acetate propionate, ethyl cellulose ethoce, cyano ethyl cellulose, cyano ethyl polyvinyl alcohol and carboxy methyl cellulose.

4. The current collector structure as claimed in claim 1, wherein the polymer binder has a weight ratio to the graphene conductive layer within a range of 0.01 wt % to 10 wt %.

5. The current collector structure as claimed in claim 1, wherein the graphene conductive layer has a thickness of 0.1˜5 μm.

6. The current collector structure as claimed in claim 1, wherein the graphene conductive layer has a resistivity less than 1 Ω-cm.

7. The current collector structure as claimed in claim 1, wherein the graphene conductive layer has an adhesion force to the metal foil substrate, which is tested by a cross-cut method and classified with larger than or equal to 4B level.
